(19) United States
(12) Patent Application Publication
(10) Pub. No.: US 2024/0412367 A1
(43) Pub. Date: Dec. 12, 2024

(54) SYSTEMS, METHODS, AND APPARATUSES FOR IMPLEMENTING IMPROVED SELF-SUPERVISED LEARNING TECHNIQUES THROUGH RELATING-BASED LEARNING USING TRANSFORMERS

(71) Applicant: Arizona Board of Regents on behalf of Arizona State University, Scottsdale, AZ (US)

(72) Inventor: Jianming Liang, Scottsdale, AZ (US)

(21) Appl. No.: 18/674,642

(22) Filed: May 24, 2024

Related U.S. Application Data
(60) Provisional application No. 63/471,937, filed on Jun. 8, 2023.

(51) Int. Cl. G06T 7/00; G06T 7/11; G06V 10/764; G06V 10/778

(52) U.S. Cl. CPC G06T 7/0014; G06T 7/11; G06V 10/764; G06V 10/7792; G06T 2207/10116; G06T 2207/20021; G06T 2207/20081; G06T 2207/20132; G06T 2207/30004; G06T 2207/30061; G06V 2201/03

(57) ABSTRACT

A system implements self-supervised learning through contrastive learning using an image transformer. The transformer receives medical images for training an Artificial Intelligence (AI) model, and executes a first cropping and prediction operation by (i) cropping a first patch P from a first random location L from an image A selected from the plurality of medical images and (ii) training a classification head to predict that the first patch P is part of the image A. The transformer executes a second cropping and prediction operation by (iii) cropping a second patch P from a second random location L from the image A selected from the plurality of medical images and (iv) training the classification head to predict that the second patch P forms no part of an image B selected from the plurality of medical images. The transformer issues a determination that the image B is different than the image A.

### CLAIM OF PRIORITY

This application claims the benefit of U.S. Provisional Patent Application No. 63/471,937, filed Jun. 8, 2023, entitled “SYSTEMS, METHODS, AND APPARATUSES FOR IMPLEMENTING IMPROVED SELF-SUPERVISED LEARNING TECHNIQUES THROUGH RELATING-BASED LEARNING USING TRANSFORMERS”, the disclosure of which is incorporated by reference herein in its entirety.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

This document contains material which is subject to copyright protection. The copyright owner has no objection to the facsimile reproduction by anyone of the document or the material, as it appears in the Patent and Trademark Office patent file or records, but otherwise reserves all copyright rights whatsoever.

### TECHNICAL FIELD

Embodiments of the invention relate generally to the field of medical imaging and analysis using a convolutional neural network and a transformer for the classification and annotation of medical images, and more particularly, to systems, methods, and apparatuses for implementing improved self-supervised learning techniques through relating-based learning using a transformer, in the context of medical image analysis.

### BACKGROUND

Machine learning models have various applications to automatically process inputs and produce outputs considering situational factors and learned information to improve output quality. One area where machine learning models, and neural networks in particular, provide high utility is in the field of processing medical images.

Within the context of machine learning and deep learning specifically, a Convolutional Neural Network (CNN, or ConvNet) is a class of deep neural networks very often applied to analyzing visual imagery. Convolutional Neural Networks are regularized versions of multilayer perceptrons. Multilayer perceptrons are fully connected networks, such that each neuron in one layer is connected to all neurons in the next layer, a characteristic which often leads to a problem of overfitting of the data and the need for model regularization. Convolutional Neural Networks also seek to apply model regularization, but with a distinct approach. Specifically, CNNs take advantage of the hierarchical pattern in data and assemble more complex patterns using smaller and simpler patterns. Consequently, on the scale of connectedness and complexity, CNNs are on the lower extreme.

Unfortunately, other representative techniques require multiple transformers or CNNs and achieve sub-optimal results. What is needed is a technique for realizing improved SSL learning through the use of contrastive or “relating” learning which does not require the use of multiple transformers. The present state of the art may therefore benefit from the systems, methods, and apparatuses for implementing improved self-supervised learning techniques through relating-based learning using a single transformer, as is described herein.

### BRIEF DESCRIPTION OF THE DRAWINGS

Embodiments are illustrated by way of example, and not by way of limitation, and can be more fully understood with reference to the following detailed description when considered in connection with the figures in which:

FIGS. 1A and 1B depict exemplary cropping and generalizing operations, in accordance with described embodiments;

FIGS. 2A and 2B depict the implementation of hierarchical consistency in embedding, in accordance with described embodiments;

FIG. 3 depicts sub-operations for generalizing the hierarchically consistent implementation, in accordance with described embodiments;

FIGS. 4A, 4B, and 4C depict an exemplary POPAR architecture, in accordance with described embodiments; and

FIG. 5 depicts an exemplary technique for associating medical image patches with gray codes, in accordance with described embodiments.

### DETAILED DESCRIPTION

Described herein are systems, methods, and apparatuses for implementing improved self-supervised learning techniques through relating-based learning using a single transformer, in the context of medical image analysis.

### INTRODUCTION

A transformer offers great advantages for inventing novel loss functions to exploit the known correspondences among patches, e.g., reflexive (itself), hierarchical (part-whole), neighboring, and symmetrical relationships between patches.

For instance, a student-teacher model can be utilized for coding relationships between a pair of Patches P and Q. Consider Patch P is given to the student as input, while Patch Q is provided to the teacher as input. The relationships, including reflexive (itself), hierarchical (part-whole), neighboring, and symmetrical relationships, between Patches P and Q, are known and encoded in the two patches, and the relationships will be used in pre-training.

Rather than using a predefined merging process in a Swin Transformer, alternative processing may also randomly merge neighboring patches to dynamically generate new hierarchical relationships for deep models to learn compositional embedding for each patch from those of its components. The learned embedding may then be forced to possess such properties of locality and composition.

A new learning perspective for relating parts with the whole: Described herein are techniques by which to relate the parts back to a whole during SSL learning operations. For instance, according to such techniques, operation (1) will crop a patch P at a random location L from Image A and train a classification head to predict that patch P is part of Image A. Next, processing continues with operation (2) which will crop a patch P at a random location L from Image A and train a classification head to predict that patch P is not part of Image B, where Image B is different from Image A. Note that it is permissible for Patch P to be one of the patches of Image A that are provided as input to a transformer, although this permissible event is improbable, as it is cropped at a random location L from Image A.

A New Learning Perspective for Contrastive (Relating) Learning with a Transformer:

Further described herein are techniques by which to perform contrastive learning with a transformer, also called “relating learning” with the use of a transformer. Such exemplary processing includes operation (1) in which the operation picks images A and B, operation (2) in which processing takes, captures, or receives two large crops from Images A and B: identified as crops A1, A2, B1 and B2. Next, processing includes operation (3) in which processing then designs and implements a transformer T to take the two input image crops separated with a separator and augmented with masked attention to allow attention with each image and yet no attention across the two images. Lastly, processing concludes with operation (4) by training transformer T to recognize and predict that the crops (A1, A2) and (B1, B2) belong to the same image and that (A1, B1) (A1, B2) (A2, B1), and (A2, B2) belong to different images. This methodology is differentiated from other representative techniques for contrastive learning given that the disclosed methodology requires the use of only a single transformer or CNN.

A New Learning Perspective for Relating Patches with Global and Local Consistencies:

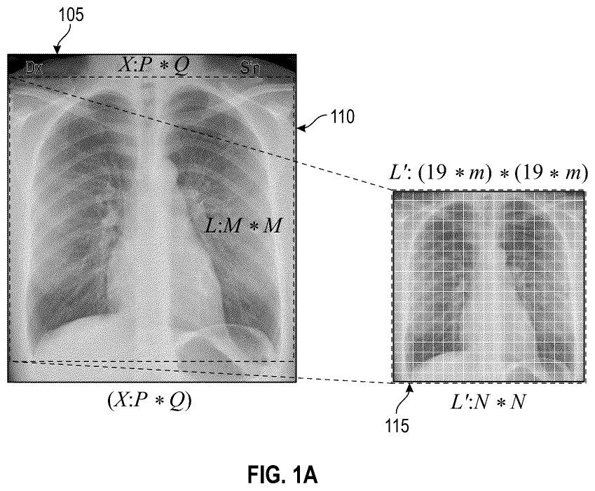

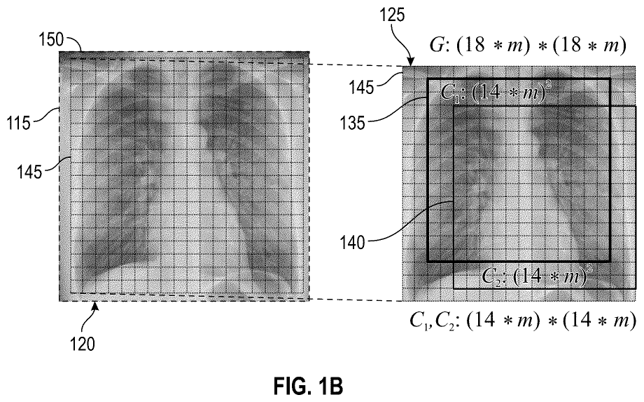

FIGS. 1A and 1B depict exemplary cropping and generalizing operations, in accordance with described embodiments. Such exemplary processing begins with operation (1) in which processing implements the global consistency of embedding between Patch C₁ depicted at 135 and Patch C₂, depicted at 140 in FIG. 1B and as described in greater detail via the following detailed sub-operations with reference to elements 105, 110, 115, 120, 125, 135, 140, 145 and 150 in FIGS. 1A and 1B.

Sub-operations for implementing the global consistency of embedding between Patch C₁ and Patch C₂ (e.g., operation 1):

As depicted with reference to FIG. 1A, according to embodiments of the invention, the process begins with operation (1) starting with an arbitrary chest X-ray X of size P=Q (see FIG. 1A, element 105), and taking a large crop L of size M*M (see FIG. 1A, element 110), which, in this example, covers 95% of the original arbitrary chest X-ray X.

Next, continuing with reference to FIG. 1A, the process continues with operation (2) by resizing as depicted at 115 the large crop L of size M*M of the original X-ray X of size P*Q to L′ of size N*N (see FIG. 1A, element 110), where N is (19*m), with m being the size of individual patches, so that L′ can be conveniently divided into 19*19 patches (see 19×19 grid at 115), with each patch of size m*m, resulting in the divided crop and resized crop of the original chest X-ray as shown at element 115 of FIG. 1A. While the depicted embodiment specifies specific values for P, Q, M, L, L′ and m, and a specific constant, 19, for the number of patches in each direction of the grid at 115, it is appreciated that one or more of those values may be changed without departing from the invention.

Now, with reference to FIG. 1B, proceed to operation (3), embodiments created at 120 from resized large crop L′ 115 new grids (dashed-line grids) G of 18×18 patches 145. Note that the origins of the new grids G has an origin placed at (a, b) in the resized large crop L′ 115, where 0≤a≤m−1 and 0≤b≤m−1, and in which this step is used to generate pixel-based dense embedding by varying a and b.

Next, the process continues, with reference to FIG. 1B, to operation (4) depicted at 125 by taking two small crops, specifically Crop C₁ (depicted at 135) and Crop C₂, (depicted at 140). Note that each of the two crops, Crop C₁ 135 and Crop C₂ 140, contains contiguously connected patches of 14×14.

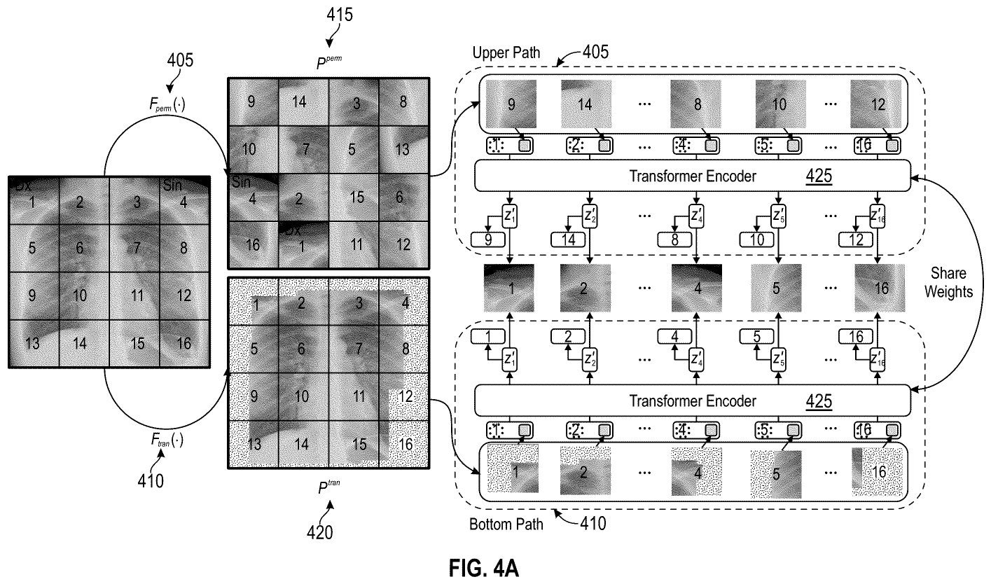

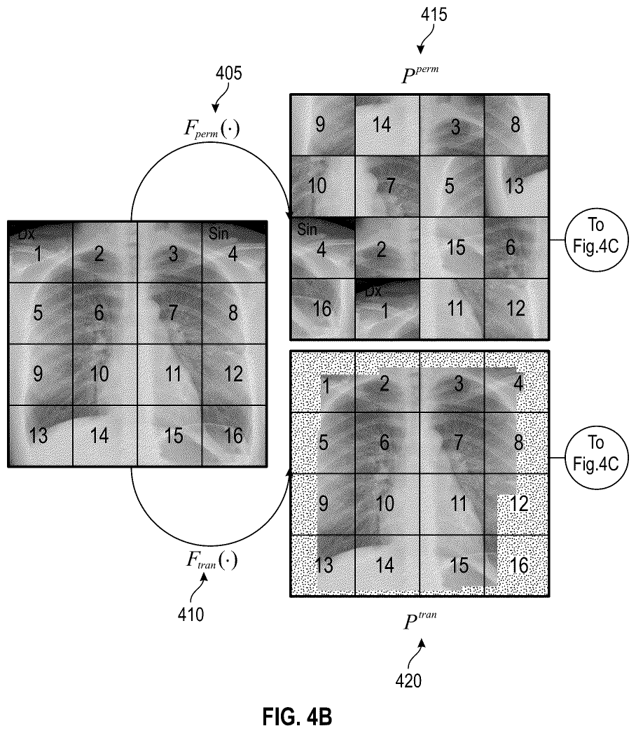

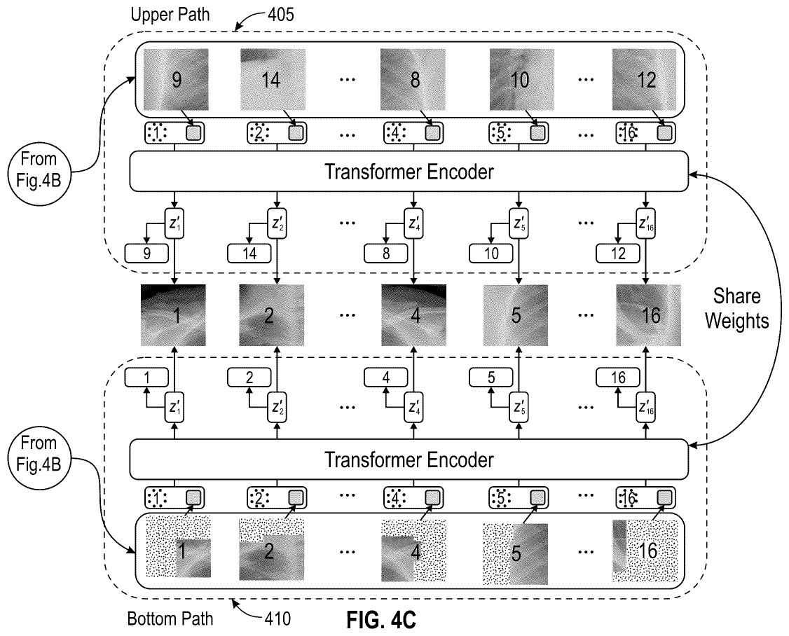

Lastly, as further discussed below with reference to FIGS. 4A-4C, embodiments proceed to operation (5) by inputting Crop C₁ 135 to the teacher and Crop C₂ 140 to the student in a student-teacher model with a transformer (ViT or Swin) as a backbone to enforce the global embedding consistency between Crop C₁ and Crop C₂, as well as to enforce the local consistency in the contextualized embedding for each pair of overlapped patches.

Note here that in the event term m is 16, for instance, as will be the case with POPAR with a ViT-B backbone, then term N is 304=(19*16), term G is 288*288=(18*16)*(18*16), and Crop C₁ and Crop C₂ are 224*224=(14*16)*(14*16). Conversely, in the event term m is 32, as will be the case with POPAR with a Swin-B backbone, then term N is 608=(19*32), term G is 576*576=(18*32)*(18*32), and Crop C₁ and Crop C₂ are 448*448=(14*32)*(14*32).

Processing continues with operation (2), by implementing the local consistency of embedding between each pair of overlapped patches described above with respect to operation (1) and as detailed by elements 105, 110, 115, 120, 125, 135, 140, 145 and 150 at FIGS. 1A and 1B.

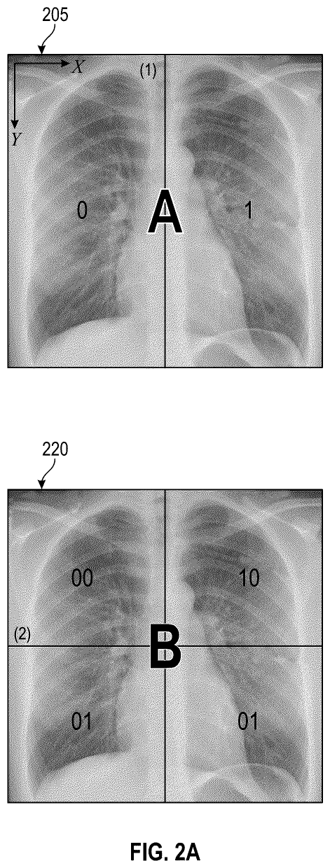

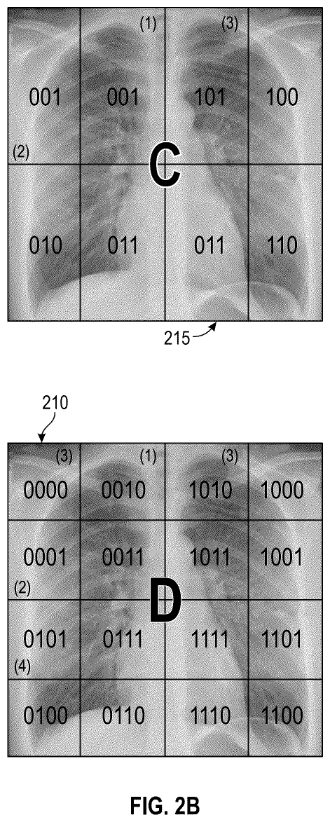

Processing then continues with operation (3), by implementing hierarchical consistency as depicted in FIGS. 2A and 2B in accordance with described embodiments. As shown, there are multiple depictions of an exemplary chest X-ray, including chest X-rays A, B, C, and D corresponding to elements 205 and 210 at FIG. 2A and elements 215 and 220 at FIG. 2B.

Each X-ray A, B, C and D at 205, 210, 215 and 220, is divided into another level of patches. For example, X-ray A 205 is divided into two patches, X-ray B 210 divided again into four patches, X-ray C 215 divided again into eight patches and X-ray D 220 divided again into sixteen total patches. The number of digits in Gray code in each patch is referred to as the Gray code level. That is, A, B, C, D have levels of 1, 2, 3, and 4, respectively, dividing the X-rays into 1×2, 2×2, 2×4, and 4×4 patches. Each patch is associated with a unique Gray code as denoted in the figures.

Between any two neighboring patches, only one binary digit (bit) changes in their Gray codes, according to an embodiment. The Gray codes not only capture relative and hierarchical relationships of anatomical structures within chest X-rays, but also encode the patterns of anatomical structures across chest X-rays.

A low-level Gray code is represented with a high-level Gray code by introducing an asterisk “*” symbol, according to an embodiment. For example, a 1-bit Gray code (Level 1) can be represented with a 4-bit Gray code (level 4), as follows: “0***”, which represents all patches with 0 at the most significant bit at the left-half image (see images A 205 and D 220 in FIGS. 2A and 2B, respectively). As another example, the representation “*1**” contains all eight patches at the bottom-half of image D 220. The representation “1*1*” indicates the four patches in a column located at the central right part of image D 220 at FIG. 2B). As a final example, the representation “*1*0” corresponds to the bottom-most row of four patches in the image D 220.

The embeddings of a whole should be equal or close to the sum of the embeddings of each of its parts. Consider the example using ϵ(ρ(g)) to represent the embedding for a patch with Gray code g. Therefore, ϵ(ρ(**11)) is the embedding for the central part of the image, and is expected to have the following properties:

$$\\ ϵ ( ϱ {(}_{} {}^{**} 11 ) ) \approx ( ϵ ( ϱ {(}_{} {}^{*} 011 ) ) + ϵ ( ϱ {(}_{} {}^{*} 111 ) ) ) / 2 ε \approx ( ϵ ( ϱ {(}_{} {}^{*} 011 ) ) + ϵ ( ϱ ( {1}_{} {}^{*} 11 ) ) ) / 2 ε$$

$$\\ ϵ ( ϱ {(}_{} {}^{*} 011 ) ) \approx ( ϵ ( ϱ ( 0011 ) ) + ϵ ( ϱ ( 1011 ) ) ) / 2 ε$$

$$\\ ϵ ( ϱ {(}_{} {}^{*} 111 ) ) \approx ( ϵ ( ϱ ( 0111 ) ) + ϵ ( ϱ ( 1111 ) ) ) / 2 ε$$

$$\\ ϵ ( ϱ ( {0}_{} {}^{*} 11 ) ) \approx ( ϵ ( ϱ ( 0011 ) ) + ϵ ( ϱ ( 0111 ) ) ) / 2 ε$$

$$\\ ϵ ( ϱ ( {1}_{} {}^{*} 11 ) ) \approx ( ϵ ( ϱ ( 1011 ) ) + ϵ ( ϱ ( 1111 ) ) ) / 2 ε$$

Note that not all equalities are listed above.

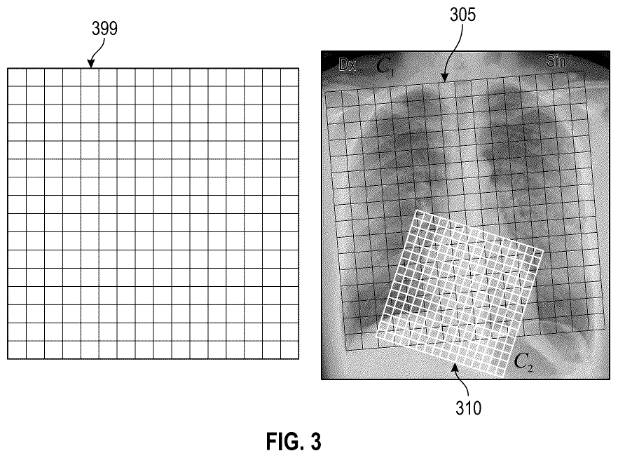

Processing continues with operation (4) which performs generalizing of the implementation in accordance with the sub-operations depicted in FIG. 3, in accordance with described embodiments. Sub-operations for generalizing the implementation are as follows:

Sub-processing begins with operation (1) for designing and implementing a grid template of g*g with each patch of size m*m. Next, sub-processing continues at operation (2) with factors f₁ and f₂, which derive two Grids G₁ and G₂, whose patch of size m₁*m₂ and m₁*m₂, respectively. Next, sub-processing continues at operation (3) in which Crop C₁ and Crop C₂ are based on the two Grids G₁ and G₂, respectively (refer to element 399). Next, sub-processing continues at operation (4) which establishes local patch correspondence between Crop C₁ depicted at 305 and Crop C₂ depicted at 310, where some local patches in the smaller crop (i.e., Crop C₂ 310 may need be merged to match with the local patches in the bigger crop (i.e., Crop C₁ 305. Lastly, the sub-processing continues at operation (5) in which each of Crop C₁ and Crop C₂ are input into a transformer (e.g., a VIT or Swin transformer) to enforce the consistency of the contextualized embedding for each pair of the corresponding “merged” patches.

The embedding of a merged patch may be computed as the weighted average of the embedding of each constituent local patches. A simplified version for implementing sub-operations (4) and (5) is as follows: (a) randomly select n₁ patches from Crop C₁, and for each patch pᵢ from the n₁ patches, find a patch, denoted as p′ᵢ in Crop C₂ containing the center of patch pᵢ from Crop C₁. Next, operation (b) randomly selects n₂ patches from Crop C₂ and for each patch pⱼ from the n₂ patches, find a patch, denoted as p′ⱼ in Crop C₁ containing the center of patch pⱼ from Crop C₂. Next, operation (c) computes the local consistency loss between each pair: (pᵢ, p′ᵢ) and (pⱼ, p′ⱼ), and the consistency loss between each pair may be further weighted based on the amount of their overlap. Note that the rotation angles applied to each of Grids G₁ and G₂ should be small, and for simplicity and efficiency, they even may optionally be ignored (e.g., by setting them to zero) in the first implementation.

According to certain embodiments, the newly disclosed learning perspective technique for relating patches with global and local consistencies is built upon a POPAR framework and thus, optionally incorporates and adopts the patch order distortion and patch appearance distortion capabilities from POPAR to enhance the learning perspectives by the disclosed methodologies as set forth herein. The term POPAR corresponds to the techniques for implementing Patch Order Prediction and Appearance Recovery (“POPAR” for short) based image processing for self-supervised medical image analysis.

The POPAR framework is a novel vision transformer-based self-supervised learning framework for chest X-ray images, according to embodiments of the invention. POPAR leverages the benefits of a vision transformer and unique properties of medical imaging, aiming to simultaneously learn patch-wise high-level contextual features by correcting shuffled patch orders and fine-grained features by recovering patch appearance. For instance, POPAR pre-trained models may be transferred to diverse downstream tasks. Experimental results suggest that (1) POPAR outperforms state-of-the-art (SoTA) self-supervised models with vision transformer backbone; (2) POPAR achieves significantly better performance over all three State of The Art (SoTA) contrastive learning methods; and (3) POPAR also outperforms fully-supervised pre-trained models across architectures. In addition, an ablation study suggests that to achieve better performance on medical imaging tasks, both fine-grained and global contextual features are preferred.

POPAR is a vision transformer-based self-supervised learning method that supports both mainstream vision transformer architectures: ViT and Swin transformer. Generally, an image transformer operates by dividing an image into fixed-size patches, correctly embedding each of the patches, and concatenating positional embedding as an input to a transformer encoder.

While the transformer architecture has become the de-facto standard for natural language processing tasks, its applications to computer vision are only now being realized. For the ViT, reliance on CNNs is not mandatory and a pure transformer applied directly to sequences of image patches can perform very well on image classification tasks. When pre-trained on large amounts of data and transferred to multiple mid-sized or small image recognition benchmarks (e.g., such as using ImageNet, CIFAR-100, VTAB, etc.), the Vision Transformer (ViT) type image transformer attains excellent results compared to state-of-the-art convolutional networks while requiring substantially fewer computational resources to train.

The Swin transformer can serve as a general-purpose backbone for computer vision. Challenges in adapting a transformer from language to vision arose from differences between the two domains, such as large variations in the scale of visual entities and the high resolution of pixels in images compared to words in text. The Swin transformer addresses these differences using a hierarchical transformer whose representation is computed with shifted windows. The shifted windowing scheme brings greater efficiency by limiting self-attention computation to non-overlapping local windows while also allowing for cross-window connection. This hierarchical architecture has the flexibility to model at various scales and has linear computational complexity with respect to image size. These qualities of a Swin transformer makes it compatible with a broad range of vision tasks, including image classification.

FIGS. 4A, 4B, and 4C depict an exemplary POPAR architecture, in accordance with described embodiments. More specifically, FIG. 4A shows the overall POPAR architecture, whereas FIGS. 4B and 4C show the same exemplary POPAR architecture as FIG. 4A but broken into separate figures to display the architecture in greater detail.

The described POPAR methodology learns (1) contextualized high-level anatomical structures via patch order prediction, and (2) fine-grained image features via patch appearance recovery. For each image, the image is first divided into a sequence of non-overlapping patches, and further processing randomly distorts the patch order via the upper path or randomly distorts the patch appearances via the bottom path.

The distorted patch sequence is then provided to a transformer network, and the model is then trained to predict the correct position of each input patch and to also recover the correct patch appearance for each position as the original patch sequence.

Image context learning: Image context has been experimentally demonstrated to be a powerful source for learning visual representations via SSL. Multiple pretext tasks have been formulated to predict the context arrangement of image patches, including predicting the relative position of two image patches, specifically for solving Jigsaw puzzles and playing Rubik's cube.

Each of these methodologies employ multi-Siamese CNN backbones as feature extractors, followed by additional feature aggregation layers for determining the relationships between the input patches. However, the feature aggregation layers are discarded after the pre-training step, and only the pre-trained multi-Siamese CNNs are transferred to the target tasks. As a result, the learned relationships among image patches are mainly ignored in the target tasks.

Unlike other representative approaches, the described POPAR methodology uses a multi-head attention mechanism to capture the relationships among anatomical patterns embedded in image patches, which is fully transferable to target tasks.

Masked image modeling: By customizing and extending upon other representative masked language modeling techniques, various vision transformer-based SSL methodologies have proven beneficial for masked image modeling. For instance, the BEiT model predicts discrete tokens from masked images and the SimMIM and MAE models mask random patches from the input image and reconstruct the missing patches.

The disclosed POPAR methodologies adopts these broad strategies and also provide specialized customization and configuration specific to the context of processing medical imaging. Thus, the thus disclosed POPAR methodologies improve upon patch reconstruction and is distinguished from other representative approaches by (1) reconstructing correct image patches from misplaced patches or from transformed patches, and (2) predicting the correct positions of shuffled image patches for learning global contextual features.

Restorative learning: The restorative SSL methods learn representations by recovering original images from their distorted versions. For instance, Models Genesis has incorporated image restoration into pretext tasks by using four effective image transformations for restorative SSL in medical imaging. The TransVW technique introduced an SSL framework for learning semantic representation from the consistent anatomical structures. The CAiD technique formulates a restoration task to boost instance discrimination SSL with context-aware representations. The DiRA methodology integrates discriminative, restorative, and adversarial SSL to learn fine-grained representations via collaborative learning.

However, none of these approaches learns anatomical relationships among image patches. Conversely, the disclosed POPAR methodologies described herein employ a transformer backbone to integrate restorative learning with patch order prediction, capturing not only visual details but also relationships among anatomical structures, according to the embodiments.

### The Popar Method:

Notations: Given an image sample x∈ [symbol] ^{H×W×C}, where (H, W) is the resolution of the image and C is the number of channels, one of the following distortion functions are selected and applied: (a) patch order distortion Fₚₑᵣₘ(⋅) which corresponds to the upper path as shown at FIGS. 4A, 4B, and 4C or alternatively, (b) patch appearance distortion Fₜᵣₐₙ(⋅) which corresponds to the lower path as shown at FIGS. 4A, 4B, and 4C.

To apply patch order distortion, the image sample x is first divided into a sequence of n non-overlapping image patches P=(p₁, p₂, . . . , pₙ), where

$$\\ n = \frac{HxW}{{k}^{{}_{} 2}}$$

and (k,k) is the resolution of each patch. The term L=(1, 2, . . . , n) is used to denote the correct patch positions within image sample x. A random permutation operator is then applied on L to generate the permuted patch positions L^{perm}. Next, L^{perm} is used to re-arrange the patch sequence P, resulting in permuted patch sequence P^{perm}.

To apply patch appearance distortion, an image transformation operator is first applied on the image sample x, resulting in an appearance-transformed image x^{tran}. Next, x^{tran} is divided into a sequence of n non-overlapping transformed image patches P^{tran}=(p₁^{tran}, p₂^{tran}, . . . , pₙ^{tran}) Next, the patches are mapped in P^{perm} at 415 and P^{tran} at 420 into D dimension patch embeddings using a trainable linear projection layer.

The patch appearance distortion processing then continues by adding trainable positional embeddings to the patch embeddings, resulting in a sequence of embedding vectors. The embedding vectors are further processed by the transformer encoder g_{θ}(⋅) 425 to generate a set of contextual patch features Z′=(z₁′, z₂′, . . . , zₙ′). Next, Z′ is then passed onto two distinct prediction heads s_{θ}(⋅) and k_{θ}(⋅) to generate predictions p^{pop}=s_{θ}(Z′) and par=p^{ar}=k_{θ}(Z′) for performing the patch order prediction and patch appearance recovery, respectively, as described below. Lastly, [symbol] is defined as “shall be (made) equal.”

Patch order prediction predicts the correct position of a patch based on its appearance. Particularly, depending on which distortion function is selected, the prediction for p^{pop} is formulated in accordance with equation 1, as follows:

$$\\ \{ \begin{matrix}{𝒫}^{{}_{} pop} {=}^{!} {L}_{perm} & if {ℱ}_{perm} ( \cdot ) is selected \\ {𝒫}^{{}_{} pop} {=}^{!} L & if {ℱ}_{tran} ( \cdot ) is selected\end{matrix} .$$

Patch appearance recovery reconstructs the correct appearance for each position in the input sequence. The network predicts the original appearance in P regardless of which distortion function (Fₚₑᵣₘ(⋅) or Fₜᵣₐₙ(⋅)) is selected. The reconstruction prediction for p^{ar} is defined in accordance with equation 2, as follows:

[symbol]

Overall training scheme: The patch order prediction is formulated as an n-way multi-class classification task and the model is optimized by minimizing the categorical cross-entropy loss:

$$\\ {ℒ}_{pop} = - \frac{1}{B} {\sum }_{b = 1}^{B} {\sum }_{l = 1}^{n} {\sum }_{c = 1}^{n} {y}_{blc} log {}_{} {𝒫}_{blc}^{{}_{} pop} ,$$

where B denotes the batch size, n is the number of patches for each image, Y represents the ground truth (as defined above at equation 1), and where p^{pop} represents the network's patch order prediction.

The patch appearance recovery is formulated as a reconstruction task and the model is trained by minimizing the L2 distance between the original patch sequence P and the restored patch sequence p^{ar}:

$$\\ {ℒ}_{{}_{} ar} = \frac{1}{B} {\sum }_{i = 1}^{B} {\sum }_{j = 1}^{n} {‖ {p}_{j} - {p}_{j}^{{}_{} ar} ‖}_{2}^{2} ,$$

where pⱼ and pⱼ^{ar} represent the patch appearance from P and p^{ar}, respectively.

Both learning schemes are then integrated and POPAR is then trained with an overall loss function Lₚₒₚₐᵣ=λ*Lₚₒₚ+(1−λ)*Lₐᵣ, where λ is the weight to specify the importance of each loss. The formulation of the Lₚₒₚ encourages the transformer model to learn high-level anatomical structures and their relative relationships. Moreover, the definition of Lₐᵣ encourages the model to capture more fine-grained features from images.

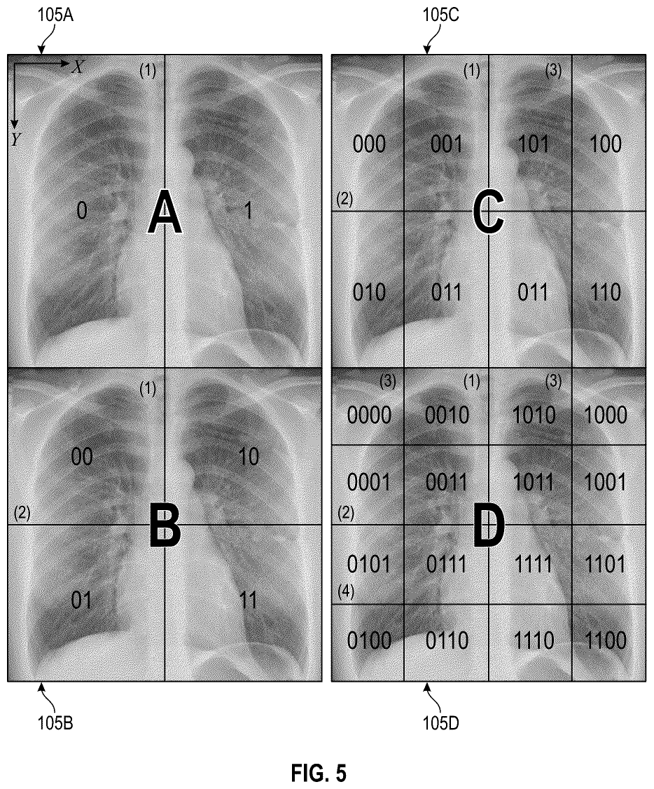

FIG. 5 depicts an exemplary technique for associating medical image patches with gray codes, in accordance with described embodiments. For a given chest X-ray, the Gray codes are created sequentially by alternatively diving it vertically (y) and horizontally (x), as shown at FIG. 5 at 105A, 105B, 105C, and 105D.

Thus, referring first to 105A, first along the y axis, the chest X-ray is divided in half, and the right-half image is coded with 1 and the left-half image is coded with 0. Given chest X-ray imaging protocol and the consistency of human anatomy, the right lung is mostly in the left-half image coded with 0, and the left lung in the right-half image coded with 1.

Then the chest X-ray is divided in half again, along the x axis (refer to 105B), and the top-half image is coded with 0 (the second digit) and the bottom-half image is coded with 1. As a result, the top right lung is likely coded with 00, the bottom right lung coded with 01, the top left lung with 10, and the bottom left lung with 11.

Next, both the right-half image which is coded with 1 and the left-half image which is coded with 0, are divided in half in half along the y axis (as depicted at 105C). Both the left part of the left-half image and the right part of the right-half image are coded with 0 (the third digit), and the central portions (i.e., the left part of the right-half image and the right part of the left-half image) are coded with 1.

Next, referring to 105D, the top-half image and the bottom-half image is again divided, and both the top part of the top-half image and the bottom part of the bottom-half image are coded with 0 (the fourth digit) and the central components (i.e., the bottom part of the top-half image and the top part of the bottom-half image) are coded with 1. This division is iteratively continued until the desired resolution is reached.

The number of digits in the Gray code is referred to as the Gray code level. Thus, each of the figures depicted at 105A, 105B, 105C, and 105D have corresponding gray coding levels of 1, 2, 3, and 4, respectively, consequently dividing the X-rays into 1×2, 2×2, 2×4, and 4×4 patches. In such a way, every patch is uniquely associated with a specific and identifiable Gray code.

Between any two neighboring patches, only one binary digit (bit) changes in the neighboring patches' Gray codes. Moreover, the Gray codes capture not only relative and hierarchical relationships of anatomical structures within chest X-rays, but also encode the patterns of anatomical structures across chest X-rays.

Thus, the disclosed embodiments contemplate a system with a memory to store instructions, and a processor to execute the instructions to implement self-supervised learning through contrastive learning using an image transformer, including: receiving a plurality of medical images at the system for training an Artificial Intelligence (AI) model; executing via the image transformer a first cropping and prediction operation by (i) cropping a first patch P from a first random location L from an image A selected from the plurality of medical images and (ii) training a classification head to predict that the first patch P is part of the image A; and executing via the image transformer a second cropping and prediction operation by (iii) cropping a second patch P from a second random location L from the image A selected from the plurality of medical images and (iv) training the classification head to predict that the second patch P forms no part of an image B selected from the plurality of medical images, and thus responsively issuing a determination that the image B is different than the image A.

In the disclosed embodiments, executing via the image transformer the first and the second cropping comprises executing, via one of a vision transformer (ViT)-type image transformer, a Swin transformer, or a Patch Order Prediction and Appearance Recovery (POPAR) transformer, the first and second cropping.

In the disclosed embodiments, executing via the image transformer the first cropping and prediction operation by (i) cropping the first patch P from the first random location L from the image A selected from the plurality of medical images and (ii) training the classification head to predict that the first patch P is part of the image A, comprises (i) cropping the first patch P from the first random location L from the image A selected from the plurality of medical images to yield a pair of cropped images A1 and A2 and (ii) training the classification head to predict that the pair of cropped images A1 and A2 are part of the image A.

The disclosed embodiments further include executing via the image transformer a third cropping and prediction operation by (i) cropping a third patch P from a third random location L from the image B selected from the plurality of medical images and (ii) training a classification head to predict that the third patch P is part of the image B.

In the disclosed embodiments, executing via the image transformer the third cropping and prediction operation by (i) cropping the third patch P from the third random location L from the image B selected from the plurality of medical images and (ii) training a classification head to predict that the third patch P is part of the image B, comprises (i) cropping the third patch P from the third random location L from the image B selected from the plurality of medical images to yield a pair of cropped images B1 and B2 and (ii) training the classification head to predict the pair of cropped images A1 and A2 are part of the image B.

The disclosed embodiments further comprise training the transformer to predict the pair of cropped images A1 and A2, and the pair of cropped images B1 and B2, are a part of image A and image B, respectively, and to predict that a pair of cropped images A1 and B1, A1 and B2, A2 and B1, and A2 and B2 belong to different images A and B.

In the disclosed embodiments, the first or the second cropping operation comprises: cropping a medical image selected from the plurality of medical images; resizing the cropped medic image to create a resized cropped image; dividing the resized cropped image into a plurality of contiguously connected patches and creating a corresponding embedding; cropping the resized cropped image into a pair of overlapping cropped images each comprising a different portion of the plurality of contiguously connected patches; receiving a first of the pair of overlapping cropped images into a student portion of a student-teacher model with the transformer as a backbone and receiving a second of the pair of overlapping cropped images into a teacher portion of the student-teacher model; and enforcing via the student-teacher model with the transformer as the backbone a global consistency of anatomical structures between the pair of overlapping cropped images.

The disclosed embodiment further comprise enforcing via a student-teacher model with the transformer as the backbone a local consistency of anatomical structures in the embedding for the pair of overlapping cropped images, and enforcing a hierarchical consistency of anatomical structures in the pair of overlapping cropped images according to a Gray coding scheme.

Embodiments of the invention contemplate a machine or system within which embodiments may operate, be installed, integrated, or configured. In accordance with one embodiment, the system includes at least a processor and a memory therein to execute instructions including implementing any application code to perform any one or more of the methodologies discussed herein. Such a system may communicatively interface with and cooperatively execute with the benefit of remote systems, such as a user device sending instructions and data, a user device to receive output from the system.

A bus interfaces various components of the system amongst each other, with any other peripheral(s) of the system, and with external components such as external network elements, other machines, client devices, cloud computing services, etc. Communications may further include communicating with external devices via a network interface over a LAN, WAN, or the public Internet.

In alternative embodiments, the system may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, the term “machine” shall also be taken to include any collection of machines (e.g., computers) that individually or jointly execute a set (or multiple sets) of instructions to perform any one or more of the methodologies discussed herein.

An exemplary computer system includes a processor, a main memory (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory (e.g., a persistent storage device including hard disk drives and a persistent database and/or a multi-tenant database implementation), which communicate with each other via a bus. Main memory includes code that implements the three branches of the SSL framework described herein, namely, the localizability branch, the composability branch, and the decomposability branch.

The processor represents one or more specialized and specifically configured processing devices such as a microprocessor, central processing unit, or the like. More particularly, the processor may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor may also be one or more special-purpose processing devices such as an application-specific integrated circuit (ASIC), a field programmable gate array (FPGA), a digital signal processor (DSP), network processor, or the like. The processor is configured to execute processing logic for performing the operations and functionality discussed herein.

The system may further include a network interface card. The system also may include a user interface (such as a video display unit, a liquid crystal display, etc.), an alphanumeric input device (e.g., a keyboard), a cursor control device (e.g., a mouse), and a signal generation device (e.g., an integrated speaker). According to an embodiment of the system, the user interface communicably interfaces with a user client device remote from the system and communicatively interfaces with the system via a public Internet.

The system may further include peripheral device (e.g., wireless or wired communication devices, memory devices, storage devices, audio processing devices, video processing devices, etc.).

A secondary memory may include a non-transitory machine-readable storage medium or a non-transitory computer readable storage medium or a non-transitory machine-accessible storage medium on which is stored one or more sets of instructions (e.g., software) embodying any one or more of the methodologies or functions described herein. The software may also reside, completely or at least partially, within the main memory and/or within the processor during execution thereof by the system, the main memory and the processor also constituting machine-readable storage media. The software may further be transmitted or received over a network via the network interface card.

In addition to various hardware components depicted in the figures and described herein, embodiments further include various operations which are described herein. The operations described in accordance with such embodiments may be performed by hardware components or may be embodied in machine-executable instructions, which may be used to cause a specialized and special-purpose processor having been programmed with the instructions to perform the operations described herein. Alternatively, the operations may be performed by a combination of hardware and software. In such a way, the embodiments of the invention provide a technical solution to a technical problem.

Embodiments also relate to an apparatus for performing the operations disclosed herein. This apparatus may be specially constructed for the required purposes, or it may be a special purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

While the algorithms and displays presented herein are not inherently related to any particular computer or other apparatus, they are specially configured and implemented via customized and specialized computing hardware which is specifically adapted to more effectively execute the novel algorithms and displays which are described in greater detail herein. Various customizable and special purpose systems may be utilized in conjunction with specially configured programs in accordance with the teachings herein, or it may prove convenient, in certain instances, to construct a more specialized apparatus to perform the required method steps. The required structure for a variety of these systems will appear as set forth in the description. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

While the subject matter disclosed herein has been described by way of example and in terms of specific embodiments, it is understood that the claimed embodiments are not limited to the explicitly enumerated embodiments. To the contrary, the disclosure is intended to cover various modifications and similar arrangements as are apparent to those skilled in the art. Therefore, the scope of the appended claims is to be accorded the broadest interpretation to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system comprising:
a memory to store instructions;
a processor to execute the instructions to implement self-supervised learning through contrastive learning using an image transformer, including:
receiving a plurality of medical images at the system for training an Artificial Intelligence (AI) model;
executing via the image transformer a first cropping and prediction operation by (i) cropping a first patch P from a first random location L from an image A selected from the plurality of medical images and (ii) training a classification head to predict that the first patch P is part of the image A; and
executing via the image transformer a second cropping and prediction operation by (iii) cropping a second patch P from a second random location L from the image A selected from the plurality of medical images and (iv) training the classification head to predict that the second patch P forms no part of an image B selected from the plurality of medical images, and thus responsively issuing a determination that the image B is different than the image A.

2. The system of claim 1, wherein executing via the image transformer the first and the second cropping comprises executing, via one of a vision transformer (ViT)-type image transformer, a Swin transformer, or a Patch Order Prediction and Appearance Recovery (POPAR) transformer, the first and second cropping.

3. The system of claim 1, wherein executing via the image transformer the first cropping and prediction operation by (i) cropping the first patch P from the first random location L from the image A selected from the plurality of medical images and (ii) training the classification head to predict that the first patch P is part of the image A, comprises (i) cropping the first patch P from the first random location L from the image A selected from the plurality of medical images to yield a pair of cropped images A1 and A2 and (ii) training the classification head to predict that the pair of cropped images A1 and A2 are part of the image A.

4. The system of claim 3, further comprising:
executing via the image transformer a third cropping and prediction operation by (i) cropping a third patch P from a third random location L from the image B selected from the plurality of medical images and (ii) training a classification head to predict that the third patch P is part of the image B.

5. The system of claim 4, wherein executing via the image transformer the third cropping and prediction operation by (i) cropping the third patch P from the third random location L from the image B selected from the plurality of medical images and (ii) training a classification head to predict that the third patch P is part of the image B, comprises (i) cropping the third patch P from the third random location L from the image B selected from the plurality of medical images to yield a pair of cropped images B1 and B2 and (ii) training the classification head to predict the pair of cropped images A1 and A2 are part of the image B.

6. The system of claim 5, further comprising training the transformer to predict the pair of cropped images A1 and A2, and the pair of cropped images B1 and B2, are a part of image A and image B, respectively, and to predict that a pair of cropped images A1 and B1, A1 and B2, A2 and B1, and A2 and B2 belong to different images A and B.

7. The system of claim 1, wherein the first or the second cropping operation comprises:
cropping a medical image selected from the plurality of medical images;
resizing the cropped medic image to create a resized cropped image;
dividing the resized cropped image into a plurality of contiguously connected patches and creating a corresponding embedding;
cropping the resized cropped image into a pair of overlapping cropped images each comprising a different portion of the plurality of contiguously connected patches;
receiving a first of the pair of overlapping cropped images into a student portion of a student-teacher model with the transformer as a backbone and receiving a second of the pair of overlapping cropped images into a teacher portion of the student-teacher model; and
enforcing via the student-teacher model with the transformer as the backbone a global consistency of anatomical structures between the pair of overlapping cropped images.

8. The system of claim 7, further comprising enforcing via the student-teacher model with the transformer as the backbone a local consistency of anatomical structures in the embedding for the pair of overlapping cropped images.

9. The system of claim 8, further comprising enforcing a hierarchical consistency of anatomical structures in the pair of overlapping cropped images according to a Gray coding scheme.

10. A computer-implemented method performed by a system having at least a processor and a memory therein to execute instructions to implement self-supervised learning through contrastive learning using an image transformer, wherein the method comprises:
receiving a plurality of medical images at the system for training an Artificial Intelligence (AI) model;
executing via the image transformer a first cropping and prediction operation by (i) cropping a first patch P from a first random location L from an image A selected from the plurality of medical images and (ii) training a classification head to predict that the first patch P is part of the image A; and
executing via the image transformer a second cropping and prediction operation by (iii) cropping a second patch P from a second random location L from the image A selected from the plurality of medical images and (iv) training the classification head to predict that the second patch P forms no part of an image B selected from the plurality of medical images, and thus responsively issuing a determination that the image B is different than the image A.

11. The method of claim 10, wherein the executing via the image transformer the first and the second cropping comprises executing, via one of a vision transformer (ViT)-type image transformer, a Swin transformer, or a Patch Order Prediction and Appearance Recovery (POPAR) transformer, the first and second cropping.

12. The method of claim 10, wherein the executing via the image transformer the first cropping and prediction operation by (i) cropping the first patch P from the first random location L from the image A selected from the plurality of medical images and (ii) training the classification head to predict that the first patch P is part of the image A, comprises (i) cropping the first patch P from the first random location L from the image A selected from the plurality of medical images to yield a pair of cropped images A1 and A2 and (ii) training the classification head to predict that the pair of cropped images A1 and A2 are part of the image A.

13. The method of claim 12, further comprising:
executing via the image transformer a third cropping and prediction operation by (i) cropping a third patch P from a third random location L from the image B selected from the plurality of medical images and (ii) training a classification head to predict that the third patch P is part of the image B.

14. The method of claim 13, wherein the executing via the image transformer the third cropping and prediction operation by (i) cropping the third patch P from the third random location L from the image B selected from the plurality of medical images and (ii) training a classification head to predict that the third patch P is part of the image B, comprises (i) cropping the third patch P from the third random location L from the image B selected from the plurality of medical images to yield a pair of cropped images B1 and B2 and (ii) training the classification head to predict the pair of cropped images A1 and A2 are part of the image B.

15. The method of claim 10, wherein the first or the second cropping operation comprises:
cropping a medical image selected from the plurality of medical images;
resizing the cropped medic image to create a resized cropped image;
dividing the resized cropped image into a plurality of contiguously connected patches and creating a corresponding embedding;
cropping the resized cropped image into a pair of overlapping cropped images each comprising a different portion of the plurality of contiguously connected patches;
receiving a first of the pair of overlapping cropped images into a student portion of a student-teacher model with the transformer as a backbone and receiving a second of the pair of overlapping cropped images into a teacher portion of the student-teacher model;
enforcing via the student-teacher model with the transformer as the backbone a global consistency of anatomical structures between the pair of overlapping cropped images;
enforcing via the student-teacher model with the transformer as the backbone a local consistency of anatomical structures in the embedding for the pair of overlapping cropped images; and
enforcing a hierarchical consistency of anatomical structures in the pair of overlapping cropped images according to a Gray coding scheme.

16. A non-transitory computer readable storage media having instructions stored thereupon that, when executed by a system having at least a processor and a memory therein, cause the processor to execute instructions to implement self-supervised learning through contrastive learning using an image transformer, by performing the following operations:
receiving a plurality of medical images at the system for training an Artificial Intelligence (AI) model;
executing via the image transformer a first cropping and prediction operation by (i) cropping a first patch P from a first random location L from an image A selected from the plurality of medical images and (ii) training a classification head to predict that the first patch P is part of the image A; and
executing via the image transformer a second cropping and prediction operation by (iii) cropping a second patch P from a second random location L from the image A selected from the plurality of medical images and (iv) training the classification head to predict that the second patch P forms no part of an image B selected from the plurality of medical images, and thus responsively issuing a determination that the image B is different than the image A.

17. The non-transitory computer readable storage media of claim 16, wherein executing via the image transformer the first and the second cropping comprises executing, via one of a vision transformer (ViT)-type image transformer, a Swin transformer, or a Patch Order Prediction and Appearance Recovery (POPAR) transformer, the first and second cropping.

18. The non-transitory computer readable storage media of claim 16, wherein executing via the image transformer the first cropping and prediction operation by (i) cropping the first patch P from the first random location L from the image A selected from the plurality of medical images and (ii) training the classification head to predict that the first patch P is part of the image A, comprises (i) cropping the first patch P from the first random location L from the image A selected from the plurality of medical images to yield a pair of cropped images A1 and A2 and (ii) training the classification head to predict that the pair of cropped images A1 and A2 are part of the image A.

19. The non-transitory computer readable storage media of claim 18, further comprising:
executing via the image transformer a third cropping and prediction operation by (i) cropping a third patch P from a third random location L from the image B selected from the plurality of medical images and (ii) training a classification head to predict that the third patch P is part of the image B; and
wherein executing via the image transformer the third cropping and prediction operation by (i) cropping the third patch P from the third random location L from the image B selected from the plurality of medical images and (ii) training a classification head to predict that the third patch P is part of the image B, comprises (i) cropping the third patch P from the third random location L from the image B selected from the plurality of medical images to yield a pair of cropped images B1 and B2 and (ii) training the classification head to predict the pair of cropped images A1 and A2 are part of the image B.

20. The non-transitory computer readable storage media of claim 16, wherein the first or the second cropping operation comprises:
cropping a medical image selected from the plurality of medical images;
resizing the cropped medical image to create a resized cropped image;
dividing the resized cropped image into a plurality of contiguously connected patches and creating a corresponding embedding;
cropping the resized cropped image into a pair of overlapping cropped images each comprising a different portion of the plurality of contiguously connected patches;
receiving a first of the pair of overlapping cropped images into a student portion of a student-teacher model with the transformer as a backbone and receiving a second of the pair of overlapping cropped images into a teacher portion of the student-teacher model;
enforcing via the student-teacher model with the transformer as the backbone a global consistency of anatomical structures between the pair of overlapping cropped images;
enforcing via the student-teacher model with the transformer as the backbone a local consistency of anatomical structures in the embedding for the pair of overlapping cropped images; and
enforcing a hierarchical consistency of anatomical structures in the pair of overlapping cropped images according to a Gray coding scheme.
